(19) United States
(12) Patent Application Publication
(10) Pub. No.: US 2018/0190429 A1
(43) Pub. Date: Jul. 5, 2018

(54) WINDING METHOD FOR PROVIDING HIGH EFFICIENCY TO THE ELECTRICAL TRANSFORMER

(71) Applicant: SHREERAM PADHYE, HYDERABAD (IN)

(72) Inventor: SHREERAM PADHYE, HYDERABAD (IN)

(21) Appl. No.: 15/641,239

(22) Filed: Jul. 4, 2017

(30) Foreign Application Priority Data
Jan. 4, 2017 (IN) 201741000381

(51) Int. Cl. H01F 41/06

(52) U.S. Cl. CPC H01F 41/06

(57) ABSTRACT

Exemplary embodiments of the present disclosure are directed towards a winding method for providing high efficiency to the electrical transformer. The method comprises forming a primary winding and secondary being parallel to each other for increasing the magnetic coupling.

### TECHNICAL FIELD

The present disclosure relates to the field of electrical transformer systems. More particularly, the present disclosure relates to a winding method for providing high efficiency to the electrical transformer.

### BACKGROUND

Generally, most of the manufactures may do the winding as forming the primary winding first and then forming a secondary winding is done afterwards separately. This type of winding may provide less efficiency, maximum of 95%.

In the light of aforementioned discussion there exists a winding method for providing higher efficiency to the electrical transformer, number of turns being same.

### BRIEF SUMMARY

The following presents a simplified summary of the disclosure in order to provide a basic understanding to the reader. This summary is not an extensive overview of the disclosure and it does not identify key/critical elements of the disclosure or delineate the scope of the disclosure. Its sole purpose is to present some concepts disclosed herein in a simplified form as a prelude to the more detailed description that is presented later.

A more complete appreciation of the present disclosure and the scope thereof can be obtained from the accompanying drawings which are briefly summarized below and the following detailed description of the presently preferred embodiments.

Exemplary embodiments of the present disclosure are directed towards to a winding method for providing high efficiency to the electrical transformer.

According to an exemplary aspect, the method comprises primary winding and secondary winding. The primary winding and the secondary winding started together being parallel to each other. The winding method increases the magnetic coupling.

An exemplary objective of the present disclosure is to provide the insulation to be used on copper wire used to be Teflon coating of appropriate thickness on copper wire depending on highest potential difference and KVA rating of the transformer. Example for 11000 volts primary 1 mm thickness Teflon coating is required.

### BRIEF DESCRIPTION OF DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 (Prior-art) is a diagram depicting a winding method for providing normal efficiency to the electrical transformer.

FIG. 2 is a diagram depicting a winding method to providing higher efficiency of the electrical transformer, according to an exemplary embodiment of the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

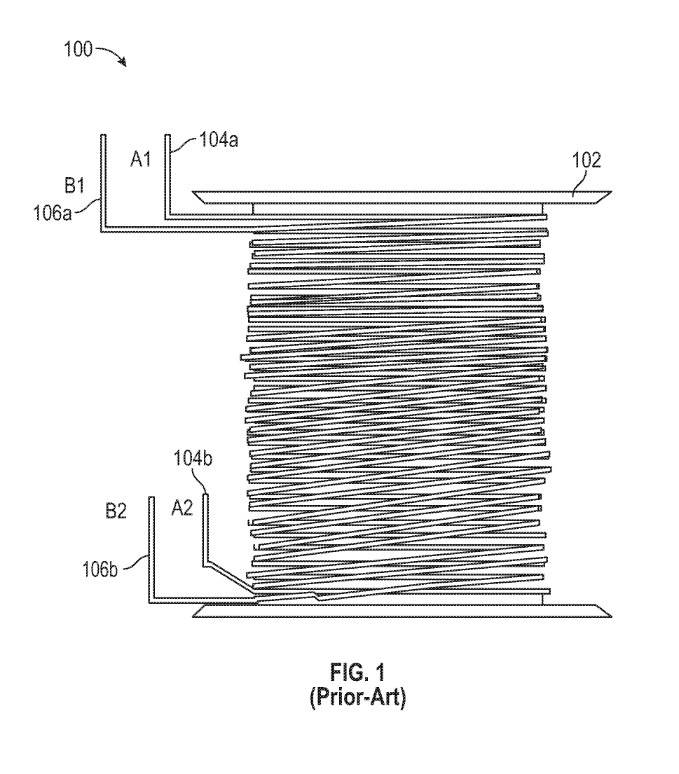

Referring to FIG. 1 (Prior-art) is a diagram 100 depicting a winding method for providing normal efficiency to the electrical transformer. The diagram comprises of a bobbin 102, a primary winding 104a-104b with ends A1 and A2 and a secondary winding 106a-106b with ends B1 and B2. The primary winding 104a-104b forms a first on the bobbin 102 completely then the secondary winding 106a-106b may be formed over the primary winding 104a-104b. The method configured to standard design in use today. This type of winding may provide less efficiency, maximum of 95%.

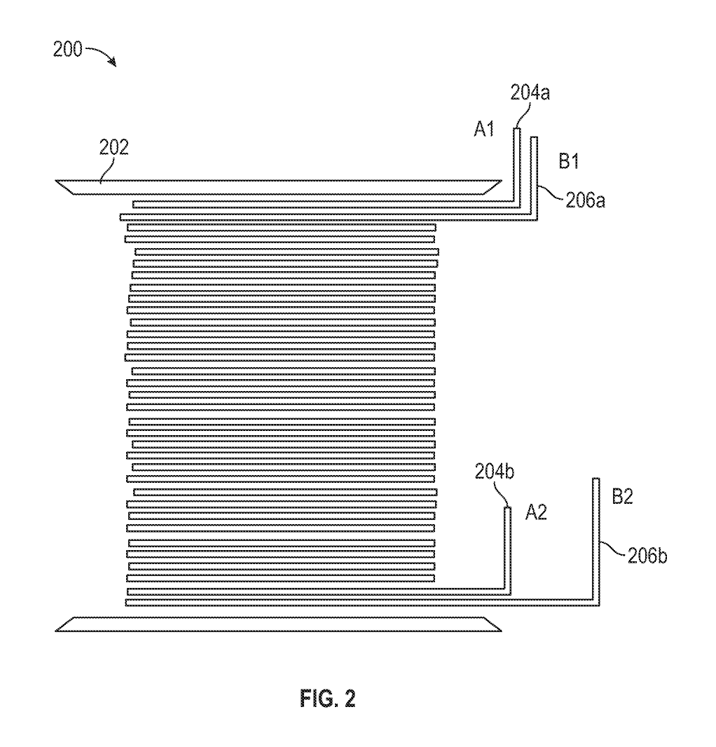

Referring to FIG. 2 is a diagram 200 depicting a winding method to providing higher efficiency of the electrical transformer, according to an exemplary embodiment of the present disclosure. The diagram comprises of a bobbin 202, a primary winding 204a-204b with ends A1 and A2 and a secondary winding 206a-206b with ends B1 and B2. As shown in the diagram 200, the primary winding 204a-204b and the secondary winding 206a-206b start together being parallel to each other. The windings 204a-204b and 206a-206b to increase the magnetic coupling. In case of distribution transformer the secondary winding 206a-206b possess smaller number of turns is terminated to the appropriate terminals and primary is continued till required no of turns are achieved, the secondary winding gets completely surrounded by primary winding 204a-204b. The parallel winding increases the magnetic coupling of the transformer due to primary winding surrounding secondary winding all four sides. This winding method provide higher efficiency, maximum of 98%. The insulation to be used on copper wire used to be Teflon coating of appropriate thickness on copper wire depending on highest potential difference within the transformer. Example for 11000 volts primary 1 mm thickness Teflon coating is required.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

What is claimed is:

1. A winding method for providing high efficiency to the electrical transformer, the method comprising:
forming a primary winding and a secondary winding together being parallel to each other.

2. The method of claim 1, wherein the parallel winding increases the magnetic coupling of the transformer due to primary winding surrounding secondary winding all four sides.

3. The method of claim 1, wherein the primary winding with two ends and the secondary winding with two ends configured for providing input and output to the transformer.
